(19) United States
(12) Patent Application Publication
(10) Pub. No.: US 2022/0141583 A1
(43) Pub. Date: May 5, 2022

(54) HEARING ASSISTING DEVICE AND METHOD FOR ADJUSTING OUTPUT SOUND THEREOF

(71) Applicant: PixArt Imaging Inc., Hsin-Chu County (TW)

(72) Inventors: Kuo-Wei KAO, Taipei (TW); Ho-Hsin LIAO, Taipei (TW); Jian-Ying LI, Taipei (TW); Kuo-Ping YANG, Taipei (TW)

(21) Appl. No.: 17/372,580

(22) Filed: Jul. 12, 2021

(30) Foreign Application Priority Data
Nov. 2, 2020 (CN) 202011205461.4

(51) Int. Cl. H04R 3/04; G10L 17/00; G10L 25/51

(52) U.S. Cl. CPC H04R 3/04; H04R 2430/01; G10L 25/51; G10L 17/00

(57) ABSTRACT

A hearing assisting device and method for adjusting output sound of the hearing assisting device are disclosed. The method comprises the following steps of: receiving a voice data; analyzing the voice data to obtain a voiceprint data and comparing the voiceprint data with a built-in voiceprint data; and if the voiceprint data matches the built-in voiceprint data, adjusting a volume of the voice data.

### BACKGROUND OF THE INVENTION

### Field of the Invention

The present invention relates to a hearing assisting device and a method for adjusting the output sound of the hearing assisting device, and more particularly, to a hearing assisting device that uses voiceprint recognition to adjust the voice of the wearer of the hearing assisting device and a method for adjusting the output sound of the hearing assisting device.

### Description of the Prior Art

Hearing assisting devices such as hearing aids or earphones with hearing aid functions can help the wearer to hear outside sounds clearly; however, most of the current hearing assisting devices cannot distinguish whether the sound comes from the outside or from the wearer himself/herself. Therefore, the hearing assisting device amplifies all the received sounds with no difference, and the wearer's own speech will also be amplified by the hearing assisting device, causing the wearer to often complain about hearing his/her voice at too loud a volume and feeling auditory discomfort.

At present, U.S. Patent Publication No. U.S. Pat. No. 9,225,306 discloses a facial motion sensor implemented in a hearing assisting device for determining and adjusting the sound made by the wearer himself/herself (that is, as described in U.S. Pat. No. 9,225,306, a technology that prevents the wearer's own sound from being over-amplified). US Patent Publication No. U.S. Pat. No. 10,021,494 discloses a vibration sensor installed in the hearing assisting device for determining if the vibration needs to be further processed in order to save power and to provide comfort to the wearer. However, both methods need to be implemented in the hearing assisting device and use sensors installed in the hearing assisting device to detect the sound emitted by the wearer, and these requirements increase the cost of the manufacturing process, so there is a need to provide a new hearing assisting device to overcome the deficits of the prior art.

### SUMMARY OF THE INVENTION

It is a main object of the present invention to provide a method that uses voiceprint recognition to adjust the wearer's own speaking voice and to adjust the output sound of a hearing assisting device

It is another object of the present invention to provide a hearing assisting device that uses voiceprint recognition to adjust the wearer's own speaking voice.

In order to achieve the above objects, the present invention discloses a hearing assisting device comprising: a sound processing unit, a microphone, a memory, and a speaker. The sound processing unit comprises a voiceprint comparison module and a volume adjustment module. The microphone is electrically connected to the sound processing unit and is used for receiving a voice message. The memory is electrically connected to the sound processing unit and is used for storing a built-in voiceprint data. The speaker is electrically connected to the sound processing unit, wherein the voiceprint comparison module is used for analyzing the voice message to obtain a voiceprint data and comparing whether the voiceprint data matches a built-in voiceprint data, and if the voiceprint data matches the built-in voiceprint data, the volume adjustment module adjusts the voice volume of the voice message.

The present invention further provides a method for adjusting an output sound of a hearing assisting device, wherein the method is suitable for the hearing assisting device. The method comprising the following steps of: receiving a voice message; analyzing the voice message to obtain a voiceprint data, and comparing whether the voiceprint data matches a built-in voiceprint data of the user; if yes, adjusting the voice volume of the voice message.

The hearing assisting device of the present invention and the method for adjusting the output sound of the hearing assisting device can identify the wearer's own speaking voice by using voiceprint recognition with no need for an additional detector in the hearing assisting device. The present invention can achieve the object of adjusting the volume of the wearer's own speaking voice, thereby improving the deficiency of prior-art techniques.

### BRIEF DESCRIPTION OF THE DRAWINGS

FIG. 1 illustrates a device architecture diagram of a hearing assisting device of the present invention; and

FIG. 2 illustrates a flowchart of the steps of a method for adjusting the output sound of the hearing assisting device of the present invention.

### DETAILED DESCRIPTION OF THE EMBODIMENTS

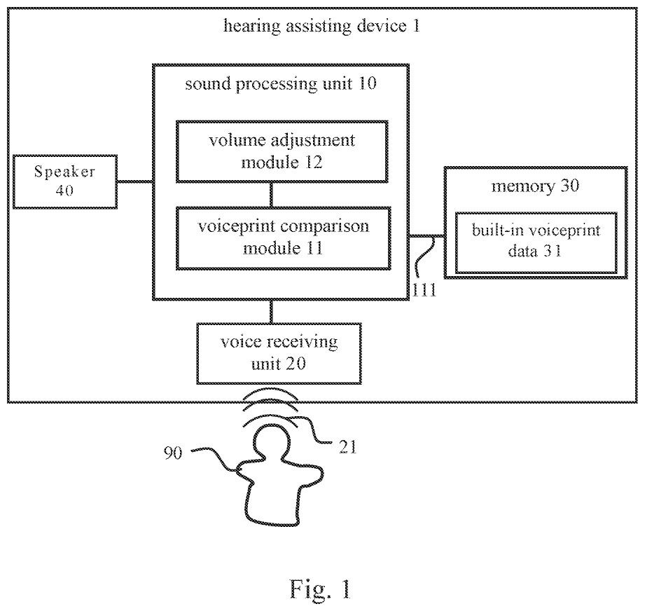

In order to better understand the technical content of the present invention, preferred embodiments are described as follows. Please refer to FIG. 1 for the device structure diagram of a hearing assisting device of the present invention.

As shown in FIG. 1, in an embodiment of the present invention, the hearing assisting device 1 of the present invention comprises a sound processing unit 10, a voice receiving unit 20, a memory 30, and a speaker 40, wherein the voice receiving unit 20, the memory 30, and the speaker 40 are all electrically connected to the sound processing unit 10. In an embodiment of the present invention, the sound processing unit 10 performs the function of the hearing assisting device 1, such as frequency shift or frequency conversion after a voice message 21 is received by the voice receiving unit 20. If a digital hearing assisting device is functioning as a hearing assisting device 1, it also provides a signal conversion function between analog and digital fields. In this embodiment, the voice receiving unit 20 is a microphone, but the present invention is not limited thereto. The voice receiving unit 20 can be a wired or wireless receiving module for receiving the voice message. In this embodiment, the sound processing unit 10 comprises a voiceprint comparison module 11 and a volume adjustment module 12, wherein the voiceprint comparison module 11 analyzes the voice message 21 to obtain the corresponding voiceprint data 111 and then compares whether the voiceprint data 111 matches the built-in voiceprint data 31 of the user 90 stored in the memory 30 in advance.

The hearing assisting device 1 can be an earphone to be worn on the ear of a user 90, or it can be built into a mobile phone or other electronic device capable of receiving and playing audio to provide an amplified auxiliary audio signal to the user 90.

If the voiceprint data 111 matches the built-in voiceprint data 31, then the voice message 21 is the voice of the user 90, and the volume adjustment module 12 adjusts the voice volume of the voice message according to a first adjustment mode. In this embodiment, the first adjustment mode is that the volume adjustment module 12 reduces the voice volume of the voice message. If the voiceprint data 111 does not match the built-in voiceprint data, then the voice message 21 is not the voice of the user 90, and the volume adjustment module 12 adjusts the voice volume of the voice message 21 according to a second adjustment mode, wherein the voice volume of the voice message adjusted according to the first adjustment mode is lower than the voice volume of the voice message adjusted according to the second adjustment mode so that the user 90 will not hear his/her own voice at a louder volume than that of other sounds from the hearing assisting device 1, such that the hearing assisting device 1 of the present invention does not amplify the voice of the user 90's own speech along with other sounds with no difference, thereby allowing the user 90 to hear his/her own voice from the speaker 40 without feeling any auditory discomfort.

It is noted that the voiceprint recognition technology is a prior-art technique with its specific content and principles published in many patents or technical documents, and is well known to those with ordinary knowledge in the field, so it will not be further described. Each of the above-mentioned units or modules can be configured as hardware devices, software programs, firmware, or a combination thereof, and can also be configured as electric circuits or other appropriate types, and each unit or module can be configured in a separate type and can also be combined with one or another. In addition, this embodiment only exemplifies a preferred embodiment of the present invention, and in order to avoid redundant description, not all possible variations and combinations are described in detail. However, those skilled in the art should understand that not all the above-mentioned modules or components are necessary. In order to implement the present invention, other detailed conventional modules or components may also be included. Each module or component may be omitted or modified as required, and there may be other modules or components between any two modules.

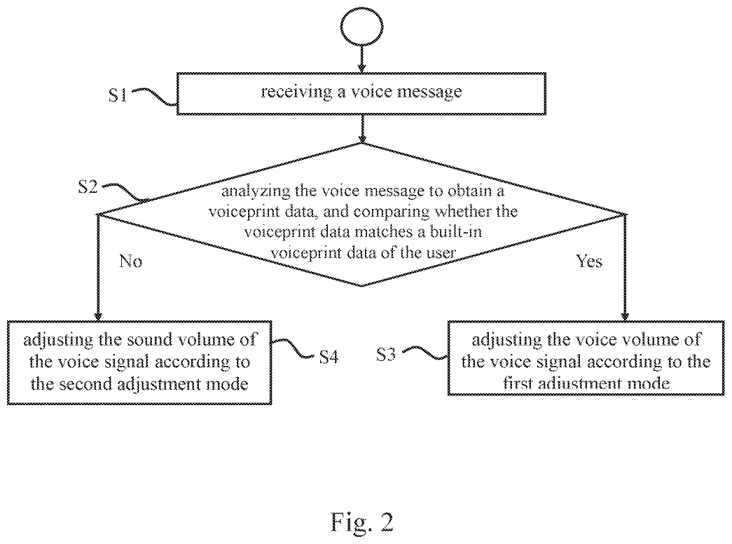

Next, please refer to both FIG. 1 and FIG. 2 together. FIG. 2 illustrates a flowchart of the steps of the method for adjusting the output sound of the hearing assisting device of the present invention. The following description will also refer to FIG. 1 to describe the steps shown in FIG. 2.

Step S1: receiving a voice message.

A voice message 21 is received by the voice receiving unit 20 of the hearing assisting device 1. In this embodiment, the voice receiving unit 20 is a microphone, but the present invention is not limited thereto. The voice receiving unit 20 can also be a wired or wireless receiving module for receiving the voice message.

S2: analyzing the voice message to obtain a voiceprint data, and comparing whether the voiceprint data matches a built-in voiceprint data 31 of the user 90.

If yes, then adjusting the voice volume of the voice message according to the first adjustment mode (step S3). If no, then adjusting the sound volume of the voice message according to the second adjustment mode (step S4).

Step S3: adjusting the voice volume of the voice message according to the first adjustment mode.

The voiceprint comparison module 11 of the sound processing unit 10 analyzes the voice message 21 to obtain a corresponding voiceprint data 111 and compares whether the voiceprint data 111 matches the built-in voiceprint data 31 of the user 90 stored in advance in the memory 30 of the hearing assisting device 1. If yes, then the voice message 21 is the voice made by the user 90 and the voice volume of the voice message is further adjusted according to the first adjustment mode.

The main function of the sound processing unit 10 is to perform the function of the hearing assisting device 1, such as frequency shift or frequency conversion, after the voice message 21 is received by the voice receiving unit 20. If a digital hearing assisting device is functioning as the hearing assisting device 1, it also provides a signal conversion function between analog and digital fields. In this embodiment, the sound processing unit 10 further comprises a voiceprint comparison module 11 and a volume adjustment module 12. The volume adjustment module 12 adjusts the voice volume of the voice message 21 according to a first adjustment mode. In this embodiment, the first adjustment mode is such that the volume adjustment module 12 reduces the voice volume of the voice message 21.

In the first adjustment mode, the volume adjustment module 12 can further divide the voice message 21 into multiple frequency bands and provide different gain values corresponding to different frequency bands. Since the first adjustment mode mainly processes the voice data that matches the voiceprint of the user 90, a frequency shift or gain control can be further performed according to the tone characteristics of the user 90's voice. For example, when the voice of the user 90 is high, then in the first adjustment mode, the high-frequency bands of the voice can be down-converted or given a smaller gain value (for example, 0.9 to 0.0001 times the magnification of other frequency bands).

Step S4: adjusting the sound volume of the voice message according to the second adjustment mode.

If the voiceprint data 111 does not match the built-in voiceprint data 31, then the voice message 21 is not the voice of the user 90 and the volume adjustment module 30 adjusts the voice volume of the voice message 21 according to the second adjustment mode, wherein the voice volume of the voice message adjusted according to the first adjustment mode is lower than that of the voice message adjusted according to the second adjustment mode.

It is noted that the frequency or other physical properties (such as digital or analog signals) of the voice message 21 of the present invention will change when processed by the sound processing unit 10 and outputted by the speaker 40, but these voice messages are still referred to as voice message 21 in the present invention to facilitate the description of the features of the present invention.

It can be seen from the above detailed description of the embodiment that the hearing assisting device 1 of the present invention and the method for adjusting the output sound of the hearing assisting device use voiceprint comparison to distinguish the voice made by the wearer of the hearing assisting device 1 from the sound from the outside world, and also use different adjustment modes to adjust these two sounds such that the hearing assisting device 1 does not amplify all the sounds with no difference; therefore, the wearer of the hearing assisting device 1 will not hear his/her voice at too loud a volume and will not feel auditory discomfort. At the same time, the hearing assisting device 1 of the present invention and the method for adjusting the output sound of the hearing assisting device can identify the wearer's own speaking voice by using voiceprint recognition with no need to add a new detector to the hearing assisting device. Therefore, the present invention can achieve the object of adjusting the volume of the wearer's own speaking voice, thereby improving the deficiency of prior-art techniques.

In summary, the present invention is very different from the conventional technology in terms of purpose, means and effects. Therefore, it would be beneficial to society if the patent is granted. It should be noted that, although the present invention is disclosed above by embodiments, the embodiments are not restrictive of the present invention. Equivalent implementation of, or equivalent changes made to, the present invention without departing from the spirit of the present invention must be deemed to fall within the scope of the present invention. Accordingly, the legal protection for the present invention should be defined by the appended claims.

What is claimed is:

1. A hearing assisting device comprising:
a sound processing unit comprising a voiceprint comparison module and a volume adjustment module;
a voice receiving unit, electrically connected to the sound processing unit, for receiving a voice message;
a memory, electrically connected to the sound processing unit, for storing a built-in voiceprint data; and
a speaker electrically connected to the sound processing unit;
wherein the voiceprint comparison module is used for analyzing the voice message to obtain a voiceprint data and for comparing whether the voiceprint data matches a built-in voiceprint data, and if the voiceprint data matches the built-in voiceprint data, the volume adjustment module adjusts the voice volume of the voice message.

2. The hearing assisting device as claimed in claim 1, wherein, when the voiceprint data matches the built-in voiceprint data, the volume adjustment module adjusts a first voice volume of the voice message according to a first adjustment mode, and when the voiceprint data does not match the built-in voiceprint data, the volume adjustment module adjusts a second voice volume of the voice message according to a second adjustment mode.

3. The hearing assisting device as claimed in claim 2, wherein the first voice volume of the voice message adjusted according to the first adjustment mode is lower than the second voice volume of the voice message adjusted according to the second adjustment mode.

4. A method for adjusting an output sound of a hearing assisting device, the method being suitable for a hearing assisting device, wherein the hearing assisting device is worn on the ear of a user, the method comprising the following steps of:
receiving a voice message;
analyzing the voice message to obtain a voiceprint data and comparing whether the voiceprint data matches a built-in voiceprint data of the user; and
if yes, adjusting the voice volume of the voice message.

5. The method as claimed in claim 4, wherein, when the voiceprint data matches the built-in voiceprint data, the volume adjustment module adjusts a first voice volume of the voice message according to a first adjustment mode, and when the voiceprint data does not match the built-in voiceprint data, the volume adjustment module adjusts a second voice volume of the voice message according to a second adjustment mode.

6. The method as claimed in claim 5, wherein the first voice volume of the voice message adjusted according to the first adjustment mode is lower than the second voice volume of the voice message adjusted according to the second adjustment mode.
